(19) United States
(12) Patent Application Publication
(10) Pub. No.: US 2012/0124194 A1
(43) Pub. Date: May 17, 2012

(54) Method and Apparatus for Efficiently Managing Network Distance between Physical Computers in a Computing Cloud

(76) Inventor: Caroline Jacqueline Shouraboura, Newcastle, WA (US)

(21) Appl. No.: 12/945,875

(22) Filed: Nov. 14, 2010

(51) Int. Cl. G06F 15/173

(52) U.S. Cl. 709/224

(57) ABSTRACT

The invention provides faster and more efficient placement recommendations for virtual machines within a computing cloud. By mapping cloud resources as points on a two-dimensional surface and using well known geometric algorithms based on Voronoi Diagrams and Delaunay Triangulation, the present invention takes advantage of the geometric proximity information inherent in those models to complete processing that normally requires Order N-squared computations in less than Order log(n) computations. The invention maintains weights on the edges of the Delaunay Triangulation representing dynamic changes in network performance. These weights modify the basic distance calculations to achieve optimal placement. This proximity information also enables consideration of durability constraints which require distance separation of virtual machines to assure uncorrelated failure.

### TECHNICAL FIELD

This invention relates to systems for storing and efficiently processing information on network performance between physical computers within a computing cloud. Computing clouds are comprised of large numbers of physical machines which dynamically host virtual machines for their users. Many aspects of operating a large computing cloud require rapid and efficient processing of the current state of network performance between one or more computers within and outside the cloud. These physical computers host virtual machines that must communicate with each other. The virtual machines are assigned to physical machines by the operator of the computing cloud, who must manage cloud capacity, make resource reservations for customers, and decide where to place virtual machines within the cloud to optimize cost and performance benefits to their customers.

### BACKGROUND OF THE INVENTION

The primary variables in deciding placement of an application on a physical computer within the Public Computing Cloud are 1) minimizing latency (and therefore bandwidth consumption) of the compute resource with respect to points on the network with which it must communicate (other compute resources, persistence layers, and endpoints outside of the cloud are a few examples) and 2) durability constraints specifying a minimum separation compute resources must have from other resources to avoid correlated failure. Other variables that could influence placement include cost of the resource, committed vs. uncommitted quality of service, and others. Latency and throughput are important variables because these are immutable characteristics of the physical layout of the cloud, dictated by such things as speed of light, network device limitations, and the network cabling connecting compute resources.

Traditional techniques for managing application placement lack the scalability required by Public Clouds. A large-scale private datacenter might contain tens of thousands of servers running well-understood applications statically allocated to servers. Even if the private datacenter is virtualized, the numbers of servers involved and the slow rates of change limit issues of scale. Much larger than private datacenters, Public Clouds today are rapidly growing to, and beyond, millions of servers scattered across different countries and continents, running dynamically changing application mixes. Many applications automatically scale up their virtual machines when they have more demand, then scale down by releasing resources as demand subsides. Frequently, applications must communicate with each other, whether for synchronizing game state, exchanging intermediate computational results, assembling web pages, or querying databases. The network in a Public Cloud supplies substantial network bandwidth in support of cross-application communication.

For a group of applications requiring communication with each other, placement proximity on the underlying physical servers is critical. Cloud Providers have a strong incentive to keep communication paths as short as possible, because the cost of provisioning bandwidth increases with distance. Latency also increases significantly with distance, so customers of a Cloud receive a better experience with shorter network paths. In order to find two or more servers which are “close” to each other, it would seem necessary to examine the latencies between all pairs of servers in the Cloud to compute an optimal placement. The calculation of latencies must be executed frequently given the network is a shared resource and is therefore subject to regular changes in performance. This means a running time of Order N-squared where N is the number of servers in the cloud. Public Clouds might have millions of servers running tens of millions of applications owned by different companies and individuals. This scale requires a high-performance computing service capable of running in near-real time.

To support the various functions of managing a cloud, an efficient mechanism for storing and processing information related to network performance must be available.

Voronoi Diagrams are a well known geometric tool for answering distance related queries. According to Wikipedia, informal use of Voronoi Diagrams can be traced back to Descartes in 1644. In 1854 a British physician, John Snow, used a Voronoi Diagram to illustrate how the majority of people who died in the Soho cholera epidemic lived closer to the infected Broad Street pump. The eponymous Russian mathematician Georgy Voronoi was the first to define and study the general n-dimensional case. In our study we use a 2-dimensional Voronoi Diagram computed for a set of n points on a plane.

Definition: The set of all points closer to a given point in a point set than to all other points in the set is an interesting geometric structure called the Voronoi Polygon for the point. The collection of all the Voronoi Polygons for a point set is called its Voronoi Diagram.

The dual graph to the Voronoi Diagram (FIG. 4) is a Delaunay Triangulation (FIG. 5). This structure was defined by Delaunay in 1934. A Delaunay Triangulation contains an edge connecting two points if and only if their Voronoi regions share a common edge. The Delaunay Triangulation DT(P) for a set P of points in the plane possesses a remarkable property such that no point in P is inside the circumcircle of any triangle in DT(P). This property characterizes a DT uniquely.

### SUMMARY OF THE INVENTION

In accordance with one embodiment of the present invention, processing of performance data related to the relative distances between computers in a computing cloud can be accomplished much faster and with fewer compute resources than was possible by the best prior art procedures. More specifically, by using the principles of the present invention, physical computers on a network within a single cloud or within a plurality of clouds can be mapped as points on a two-dimensional surface. The distances between the points represent relative network performance. By using well known geometric algorithms based upon Delaunay Triangulation, which enable the present invention to store performance information in a remarkably useful manner for computation, processing which normally requires 0(n²) many computations can be performed in less than 0(log(n)) computations. In a particular embodiment of the present invention, the physical machines which are the best targets for hosting or executing a virtual machine image, due to network proximity, can be identified in real time, or near real time, even where the numbers of potential physical machine targets exceed one million.

The procedure for achieving these markedly improved speeds and efficiencies, which will be rigorously defined hereinafter, can be readily understood by considering the Delaunay Triangulation of a set of points representing the physical locations of a set of network-connected devices, each point representing one or more devices attached to the network addressable by a single Internet Protocol address. Edges of the Delaunay Triangulation are initially assigned based on the geographical distance between the computers and network routers. These edges are then weighted with latency data collected by continuously probing the network by sending network packets between points or by sampling times for actual network packet transfers. In accordance with this embodiment of the present invention, this virtual model of the network proximity of physical computers in the cloud can be rapidly updated and processed to extract actual or expected virtual machine network performance information.

In an illustrative embodiment of the present invention, an action requiring the creation of a single virtual machine or plurality of virtual machines within a computing cloud, having specific requirements for network proximity to one or more other virtual machines, is satisfied by performing an algorithmic walk of the virtual cloud model to selectively identify closer, and therefore optimal, physical computers capable of hosting the virtual machine.

In the advantageous embodiment of the present invention, the same algorithmic walk can be performed with an additional constraint. This constraint enforces a specified minimum distance between physical machines hosting virtual machines. The physical computer chosen by the algorithm will be as close as possible without being equal to or less than a specified minimum distance from other virtual machines. This embodiment supports enforcement of a reliability constraint to reduce the probability of correlated failure of virtual machines due to shared physical proximity to an impacting event.

### BRIEF DESCRIPTION OF THE DRAWINGS

FIG. 1 depicts a typical Server Apparatus installation for the present invention, relative to the computing cloud

FIG. 2 depicts the detail of the Server Apparatus with respect to physical machines and virtual machines

FIG. 3 is a detail view of the Server Apparatus itself

FIG. 4 and FIG. 5 are background examples of the geometry used in the invention

FIG. 6 describes a typical Cloud Computing installation

FIG. 7 and FIG. 8 depict how the Server Apparatus applies the geometry to Cloud Computing components

FIG. 9 shows the Virtual Cloud Model with performance weights on the graph edges

FIG. 10 is a simplified version of FIG. 9 with routers removed

FIG. 11 depicts the method used by the Server Apparatus to identify the optimal placement for reliability

FIG. 12 depicts the method used by the Server Apparatus to identify the optimal placement location

FIG. 13 depicts the method used by the Server Apparatus to assign virtual machines to servers

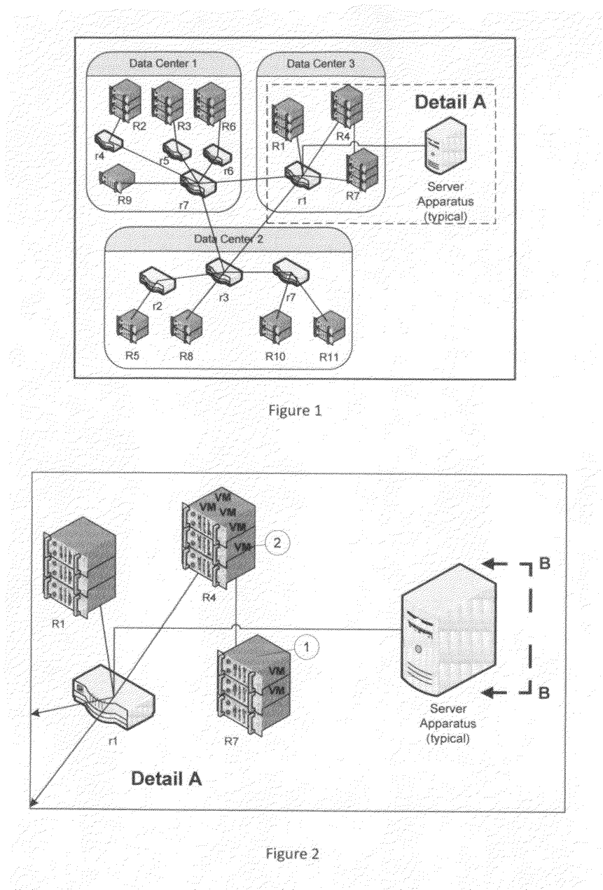

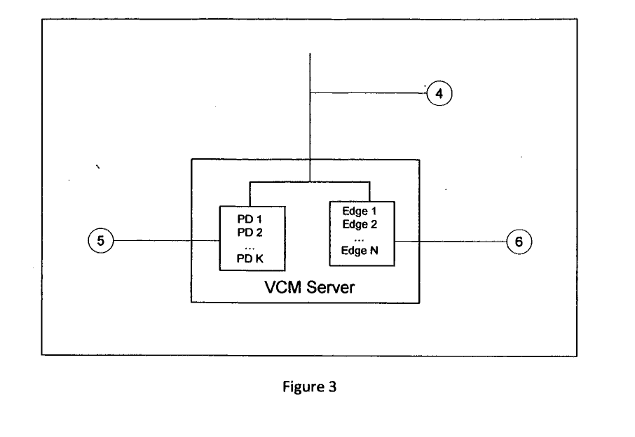

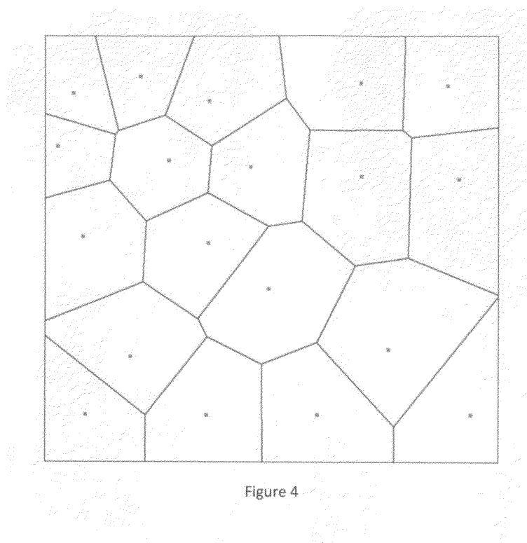

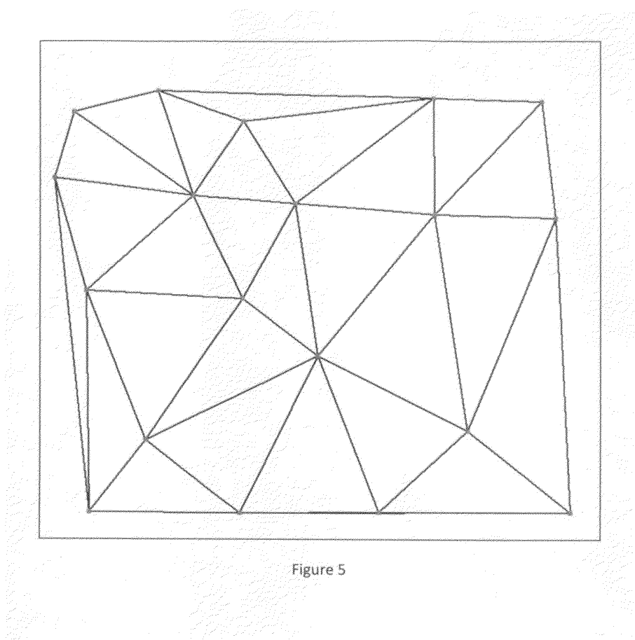

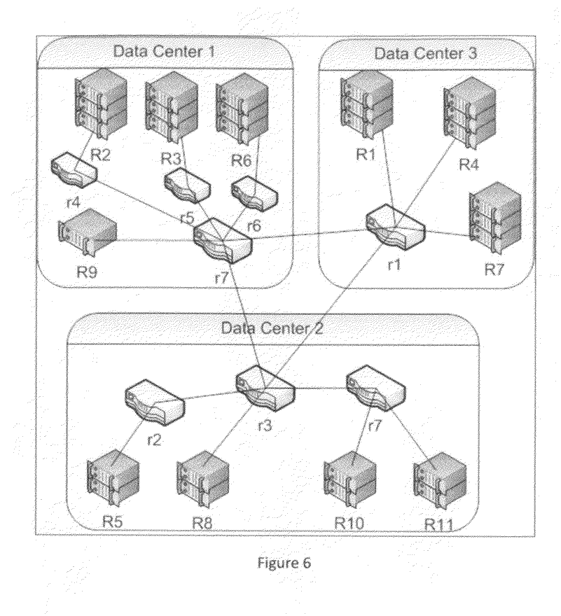

Let {D} be the union of {R} and {r}, representing all relevant devices in the Cloud. Each network connected device has an IP address, which is uniquely mapped to its geographic location using the function Location(D). This location function is readily implemented within each Cloud as part of its asset management system and is accessed by the assignment means of the Server Apparatus (“4” in FIG. 3). The geographic location of a given device is a good approximation of its network “closeness” to other devices. To best economize cost and latency, Cloud Providers keep physical cabling and network distances at a minimum, making physical location a reasonable first-order approximation of network closeness.

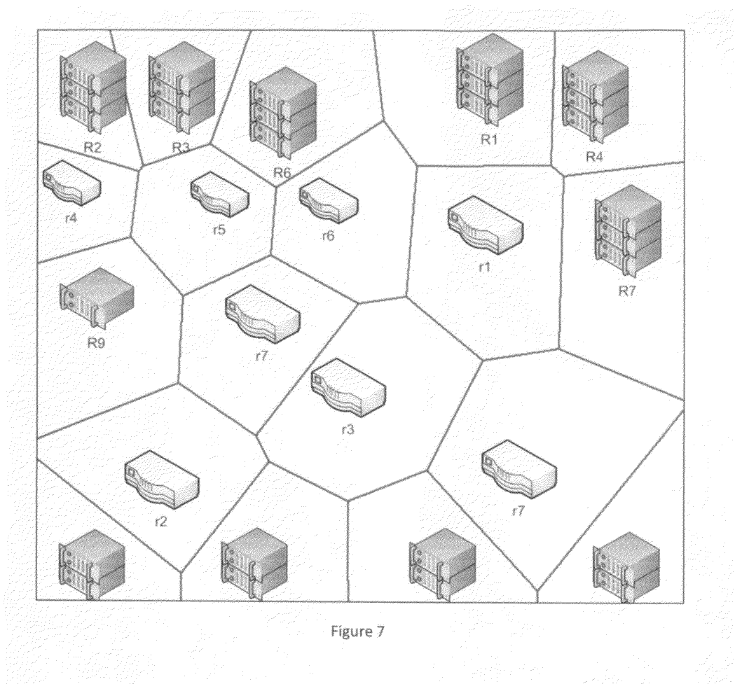

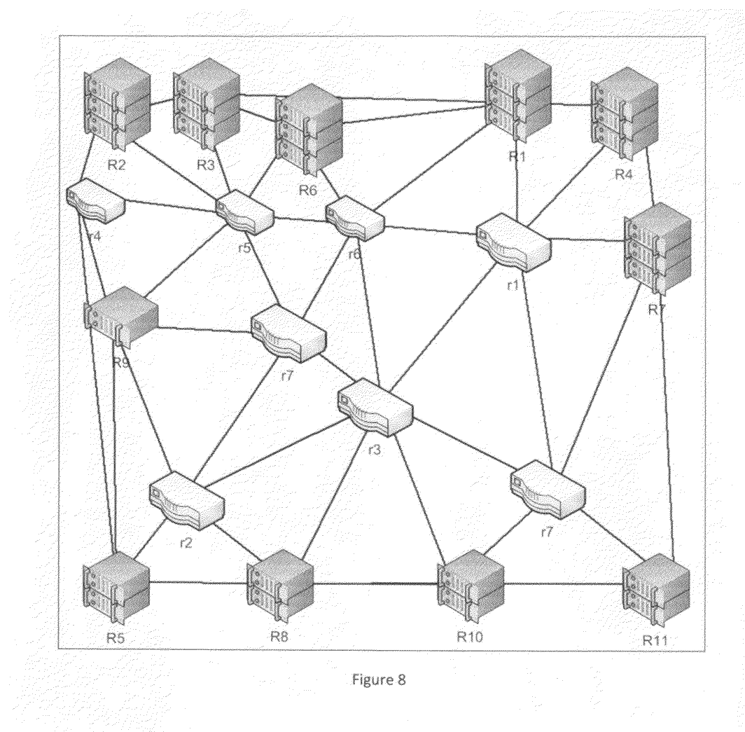

For each device in {D} the Server Apparatus calls an external function Location(D) and establishes a set of points on the plane, representing geographical coordinates of all server racks and routers on the network. The Server Apparatus performs Voronoi tessellation (FIG. 7) on the points and obtain a memory table. This table is the Physical Device Table (“5” in FIG. 3). Edges are calculated and assigned to a second table, the Edge Table” (“6” in FIG. 3), representing the Geographic Delaunay Triangulation (FIG. 8). The table is updated in 0(n * log(n)) time using 0(n) memory, where n is the number of devices. Together, these two tables are the “Virtual Cloud Model”.

The pre-computed Geographic Delaunay Triangulation is used as the foundation for processing of the Virtual Cloud Model (VCM). The Server Apparatus continually updates the VCM memory tables with network speed data to account for dynamic variables in network performance between servers. This performance variability is caused by engineering factors such as distances of cabling/fiber runs, oversubscription of bandwidth between switches and routers, routing weights for cost and redundancy, and network traffic congestion.

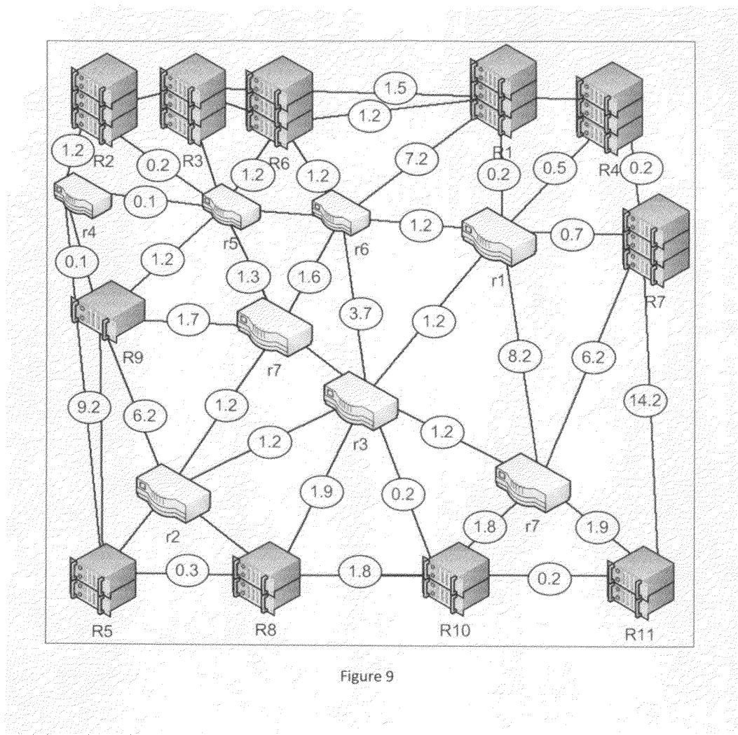

To avoid measuring network latency between each pair of devices, which would require an 0(n²) operation, the Server Apparatus limits the measurements to the edges of the pre-computed Geographic Delaunay Triangulation. It is important to note that the number of edges in Delaunay Triangulation is 0(n). For every edge the Server Apparatus captures its latency, defined as the time it takes for a packet of information to travel between its vertices in milliseconds. Memory tables are then assigned weight wₗ to every edge of Geographic Delaunay Triangulation equal to the network latency of the edge. The resulting structure is the final Virtual Cloud Model (VCM) (FIG. 9).

Using VCM, the formal definition of the “distance” between devices in the network is given as:

Definition: The distance between device D1 and device D2 in the VCM is the sum of weights of all edges on the shortest path between D1 and D2.

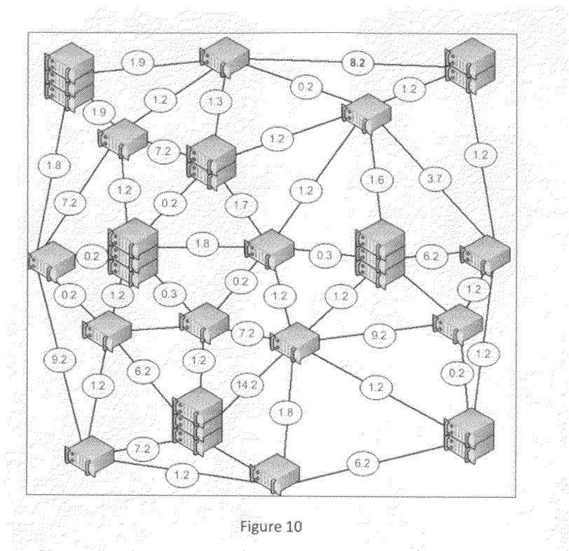

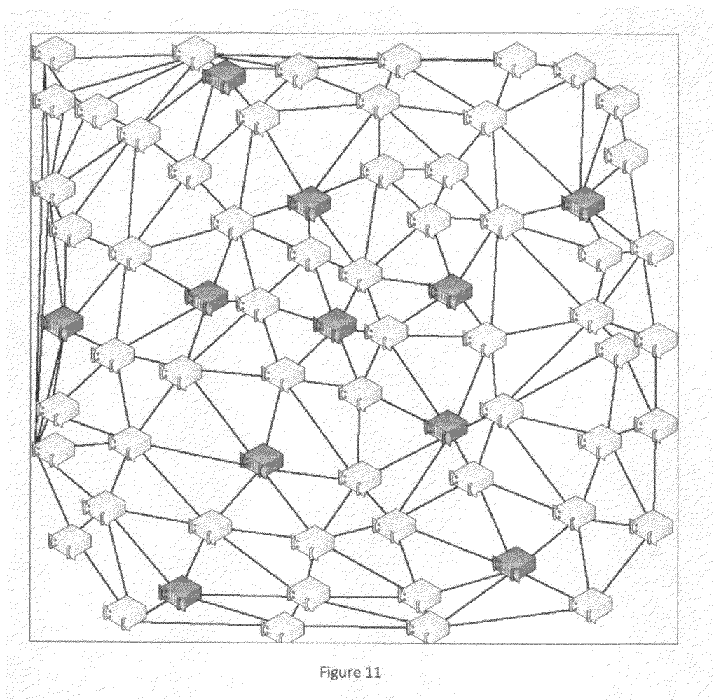

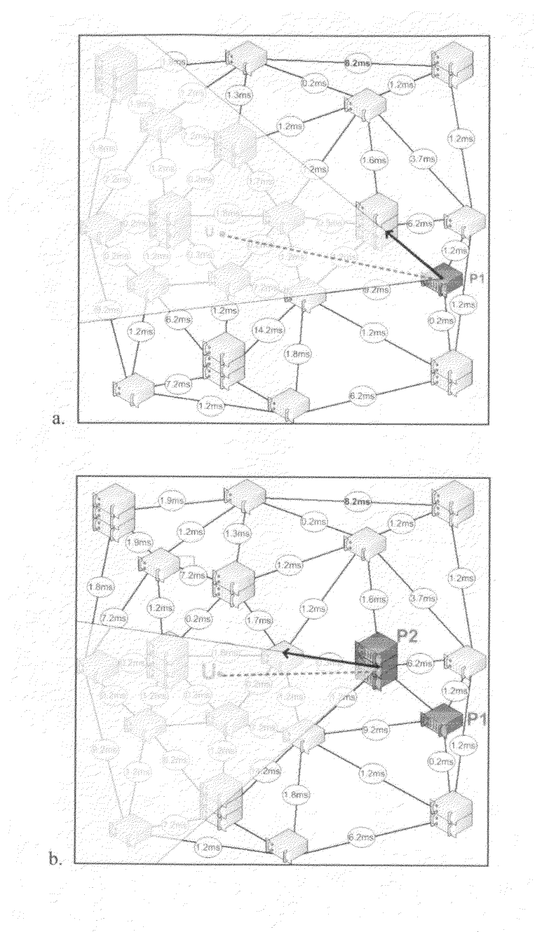

In one illustrative example of the invention, the main vertices of the VCM are server racks, each rack having a single IP address and physical location which aggregates the IP addresses and locations of all servers contained in the rack. Such model is described in (FIG. 10). In another illustrative example, we include routers, switches, load balancers and other traffic-related network devices (FIG. 9).

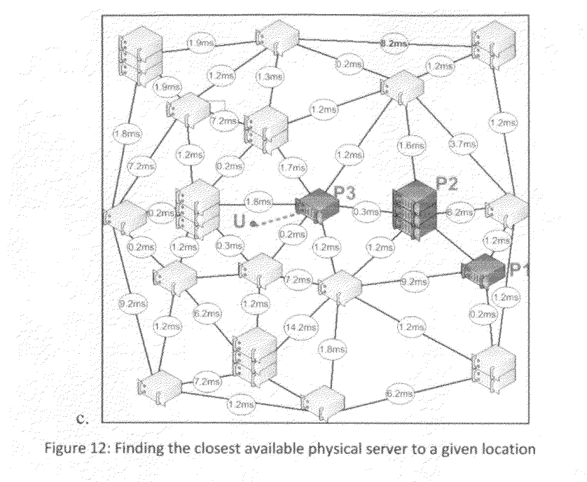

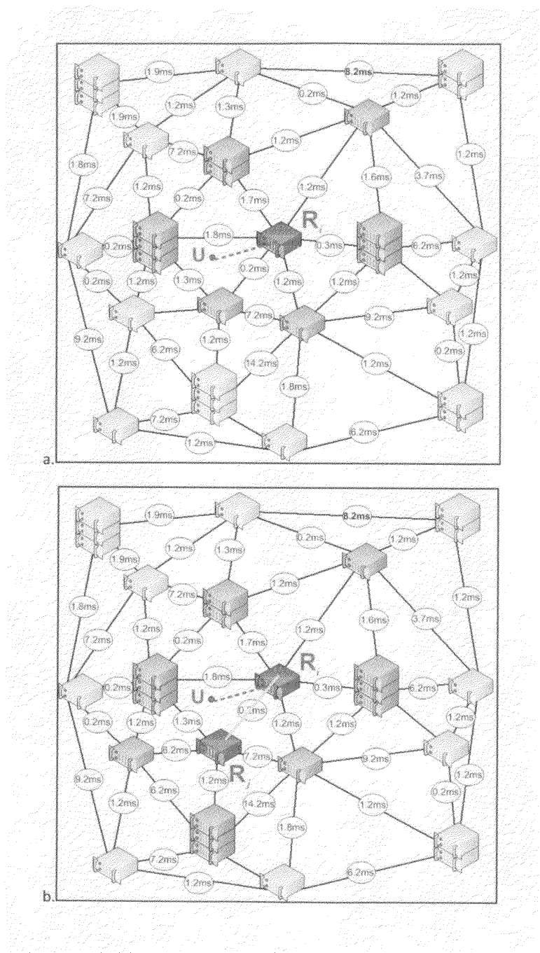

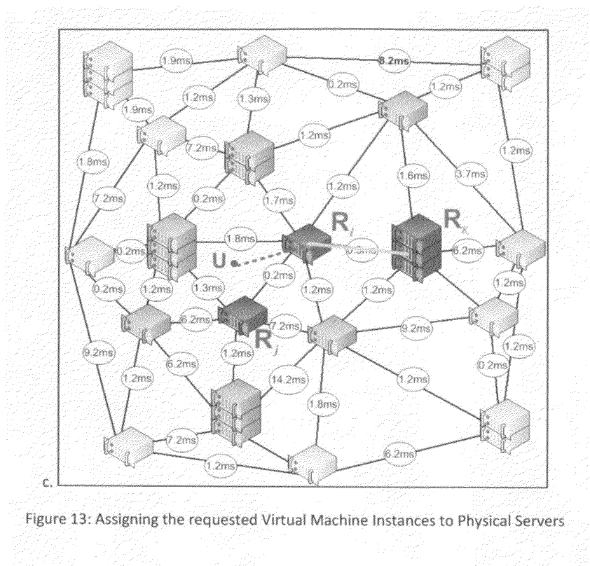

(FIG. 12) describes how the Server Apparatus identifies the triangle containing the closest available physical servers (Rᵢ) for application placement, given a user defines a desired software image I and requests k virtual machine instances running the image I, launched in proximity to location U.

The Server Apparatus then uses table means to place virtual machines on Rᵢ to run the user application until we exhaust the capacity of Rᵢ. After the first virtual machine is assigned, the remaining k-1 virtual machines are assigned to physical servers using a breadth-first search of VCM graph to find required FIG. 11 capacity, looking for the closest servers to Rᵢ.

This placement algorithm reduces latency and bandwidth consumption, for a given application, using assigning means to place parts of the application on neighboring servers by traversing the VCM and taking into the account actual, near-real-time network latency. The algorithm performs in 0(log(n)+k) time. The Server Apparatus first locates the closest server rack to user location U in 0(log(n)) time and then traverses the VCM to place k instances in 0(k) time. If the Cloud is out of capacity, the Server Apparatus may end up traversing all edges of the VCM, searching for available capacity, making the algorithm perform in 0(n), but that is an edge case mitigated by the business need for a user of the Server Apparatus to maintain available capacity.

In an advantageous embodiment of the present invention the VCM offers support for durability requirements. For “durability” placement the Server Apparatus assumes that all edge weights wₗ are equal to one, to spread instances regardless of the latest network congestion. This means that the “distance” between server racks is simply the number of edges on the shortest path on VCM graph. Similar to the previous algorithm, the customer's location U is chosen and the corresponding triangle on VCM containing U determined. The Server Apparatus picks one of the server racks associated with that triangle, but instead of exhausting its capacity, uses assigning means to place only one instance on it. A breadth-first search is performed to spread instances (FIG. 11) starting with the first server and then allocating to the next server by jumping over two (or more) Delaunay edges to ensure that there is some distance between the parts of an application. To guarantee that parts of an application are going to be placed precisely p cells away from each other, the advantageous embodiment of the Server Apparatus also computes “p-th nearest point” Voronoi diagram.

What has been described is merely illustrative of the application of the principles of the present invention. Other arrangements and methods can be implemented by those skilled in the art without departing from the spirit and scope of the present invention.

What is claimed is:

1) A server apparatus for receiving geographic location data for a plurality of devices connected to a computer network including physical computers and network routing devices, identifiable by at least one Internet Protocol address, said sever apparatus comprising assigning means for storing the locations in in-memory tables as vertices connected by edges representing the geographic distance between the vertices.

2) The server apparatus of claim 1 further comprising table means including receiving latency data for single network links between said physical computers and network devices, including aggregated latency data for a plurality of network links, and assigning means for storing said latency data associated with said graph edges where the network links are approximated by the graph edges.

3) The server apparatus of claim 1 further comprising table means including receiving occupancy information relating to the virtual machines operating at said vertices and assignment means for storing said occupancy information with said vertices.

4) The server apparatus of claim 3 comprising means including identification of a plurality of vertices having favorable network latency with respect to a given target vertex using latency estimation means comprised of successive selection of optimal edges, beginning with an arbitrary candidate vertex and traversing the optimal edge to the next candidate vertex, where the optimal edge is selected by determining the angle between each edge of the candidate vertex and a vector to said given vertex, choosing the edge with the smallest angle as optimal.

5) The server apparatus of claim 4 wherein said latency estimation means includes a further constraint of minimum distance allowed between said candidate vertex and said target vertex.
